(19) United States
(12) Patent Application Publication
(10) Pub. No.: US 2023/0410364 A1
(43) Pub. Date: Dec. 21, 2023

(54) SEMANTIC SEGMENTATION OF INSPECTION TARGETS

(71) Applicant: Kitov Systems Ltd, Petach Tikva (IL)

(72) Inventors: Ziv TSOREF, Tel-Aviv (IL); Nir AVRAHAMI, Hertzeliya (IL); Tomer SHMUL, Tel Aviv (IL)

(73) Assignee: Kitov Systems Ltd, Petach Tikva (IL)

(21) Appl. No.: 18/029,157

(22) PCT Filed: Sep. 29, 2021
(86) PCT No.: PCT/IL2021/051173

§ 371 Date: Mar. 29, 2023

Related U.S. Application Data
(60) Provisional application No. 63/084,605, filed on Sep. 29, 2020.

(51) Int. Cl. G06T 7/73; G06V 10/764

(52) U.S. Cl. CPC G06T 7/75; G06V 10/764; G06T 2207/30108; G06T 2207/30244; G06T 2207/20081; G06V 2201/06

(57) ABSTRACT

Automatic enrollment of an item of manufacture to a quality inspection system comprises using associations of enrollment images of an example of the item of manufacture to their corresponding camera poses. Enrollment images which show inspection targets (e.g., components of the item of manufacture) in views which are also suitable for use in visual inspection of further instances of the item of manufacture are identified. Their associated camera poses are selected and provided for use in inspection planning. In some embodiments, suitability of the camera pose is verified by performing inspection tests on the enrollment images.

### RELATED APPLICATION/S

This application claims the benefit of priority of U.S. Provisional Patent Application No. 63/084,605 filed on 29 Sep. 2020, the contents of which are incorporated herein by reference in their entirety.

### FIELD AND BACKGROUND OF THE INVENTION

The present invention, in some embodiments thereof, relates to the field of quality inspection and more particularly, but not exclusively, to automated visual quality inspection.

Manufactured items typically comprise a plurality of components of various types and appearances. Since defects related, e.g., to forming, assembly, and/or finishing may occur in manufacturing processes, quality inspection processes are typically introduced into production so that product quality can be confirmed, maintained, and/or improved.

Methods for performing automated quality inspection of manufactured items typically comprise machine-implemented tests intended to confirm that actual details of a particular instance of a manufactured item correspond to corresponding expectations.

International Patent Publication No. WO/2019/156783 A1, the contents of which are included herein by reference in their entirety, describes systems and methods for automated part enrollment. The process of enrollment helps to specify inspection tests, and/or baseline models to which quality inspection results may be compared.

### SUMMARY OF THE INVENTION

According to an aspect of some embodiments of the present disclosure, there is provided a method of specifying visual inspection parameters for an item of manufacture, the method including: accessing a plurality of enrollment images of an example of the item of manufacture; for each of a plurality of regions appearing in a respective image of the plurality of enrollment images, classifying the region as imaging an identified inspection target having an inspection target type; generating, using the regions and their classifications, a spatial model of the item of manufacture which indicates the spatial positioning of inspection targets and their respective inspection target types; and calculating camera poses for use in obtaining images appropriate to inspection of the inspection targets, based on their respective modeled spatial positions and inspection target types.

According to some embodiments of the present disclosure, the method includes identifying a change in an initial camera pose used to obtain at least one of the plurality of enrollment images, which the change potentially will provide an image with increased suitability for enrolling the identified inspection target, compared to the initial camera pose; obtaining an auxiliary enrollment image using the changed camera pose; and using the auxiliary enrollment image in the classifying.

According to some embodiments of the present disclosure, the calculated camera poses include camera poses not used in the enrollment images used to generate the spatial model of the item of manufacture, the calculated camera poses being relatively more suitable as inspection images of the inspection targets than the camera poses used in obtaining the enrollment images. According to some embodiments of the present disclosure, the spatial model of the item of manufacture includes relative errors in the relative positioning of at least some surfaces of at least 1 cm.

According to some embodiments of the present disclosure, the generating the spatial model includes using the classifications to identify regions in different images which correspond to the same portion of the spatial model.

According to some embodiments of the present disclosure, the generating a spatial model includes assigning geometric constraints to the identified inspection targets, based on the inspection target type classifications.

According to some embodiments of the present disclosure, the generating uses the assigned geometric constraints for estimating surface angles of the example of the item of manufacture.

According to some embodiments of the present disclosure, the generating uses the assigned geometric constraints for estimating orientations of the example of the item of manufacture.

According to some embodiments of the present disclosure, the generating the spatial model includes using the assigned geometrical constraints to identify regions in different images which correspond to the same portion of the spatial model.

According to some embodiments of the present disclosure, the enrollment images comprise 2-D images of the example of the item of manufacture.

According to some embodiments of the present disclosure, the classifying includes using a machine learning product to identify the inspection target type.

According to some embodiments of the present disclosure, the method includes imaging to produce the enrollment images.

According to some embodiments of the present disclosure, the method includes synthesizing a combined image from a plurality of the enrollment images, and performing the classifying and generating also using a region within the combined image spanning more than one of the plurality of the enrollment images.

According to some embodiments of the present disclosure, the classifying includes at least two stages of classifying for at least one of the inspection targets, and operations of the second stage of classifying are triggered by a result of the first stage of classifying.

According to some embodiments of the present disclosure, the second stage of classifying classifies a region including at least a portion of, but different in size than another region classified in the first stage of classifying.

According to some embodiments of the present disclosure, the second stage of classifying classifies a region to a more particular type belonging to a type identified in the first stage of classifying.

According to some embodiments of the present disclosure, the generating also uses camera pose data indicative of camera poses from which the plurality of enrollment images were imaged.

According to an aspect of some embodiments of the present disclosure, there is provided a method of specifying visual inspection parameters for an item of manufacture, the method including: accessing a plurality of enrollment images of an example of the item of manufacture; associating each enrollment image with a corresponding specification of a camera pose relative to the item of manufacture; for each of a plurality of regions, each region appearing in a respective image of the plurality of enrollment images: classifying the region as a representation of an identified inspection target having an inspection target type; accessing a camera pose specification defining suitable camera poses for imaging of inspection targets having the inspection target type; selecting, from among the plurality of enrollment image camera poses, at least one camera pose satisfying the camera pose specification; and providing inspection target identifications including at least types of their respective inspection targets and their respective at least one camera pose, as parameters for planning of visual inspection of instances of the item of manufacture.

According to some embodiments of the present disclosure, the method includes determining imaging overlap including same features of the example of the item of manufacture imaged in different enrollment images; and wherein the provided inspection target identifications eliminate duplication of same inspection targets, based on the determined overlap.

According to some embodiments of the present disclosure, the determining overlap includes assigning geometric constraints to the identified inspection target, based on the inspection target type classification.

According to some embodiments of the present disclosure, the determining overlap includes generating a spatial model of the item of manufacture, and determining which regions in the plurality of enrollment images image a same feature of the example of the item of manufacture.

According to some embodiments of the present disclosure, the method includes calculating at least some of the enrollment image camera poses relative to the example of the item of manufacture, using the spatial model.

According to some embodiments of the present disclosure, the generating a spatial model includes assigning geometric constraints to the identified inspection target, based on the inspection target type classification, and estimating surface angles of the example of the item of manufacture using the assigned geometric constraints.

According to some embodiments of the present disclosure, the classifying includes determining a generic class of the identified inspection target, and then a more particular sub-class of the generic class; and wherein the determining overlap includes checking that inspection target types of different inspection target identifications have the same class and sub-class.

According to some embodiments of the present disclosure, the method includes accessing at least some of the camera poses relative to the example of the item of manufacture as parameters describing how respective enrollment images were obtained.

According to some embodiments of the present disclosure, the provided inspection target identifications also specify positioning of the inspection target within images obtained using the provided at least one camera pose.

According to some embodiments of the present disclosure, the enrollment images comprise 2-D images of the example of the item of manufacture.

According to some embodiments of the present disclosure, the classifying includes using a machine learning product to identify the inspection target type.

According to some embodiments of the present disclosure, the plurality of enrollment images is collected iteratively using feedback from at least one of the classifying, accessing, and selecting performed previously.

According to some embodiments of the present disclosure, the accessed plurality of enrollment images includes at least one auxiliary enrollment image obtained using a changed camera pose refined by a process including: evaluating an initial enrollment image with an initial camera pose, according to suitability of use of the initial camera pose in visually inspecting one of the identified inspection targets; identifying a change in the initial camera pose which potentially will provide increased suitability for visually inspecting the identified inspection target, compared to the initial camera pose; and obtaining the auxiliary enrollment image using the changed camera pose.

According to some embodiments of the present disclosure, the method includes imaging to produce the enrollment images.

According to some embodiments of the present disclosure, the enrollment images are obtained according to a pattern that includes: moving the camera by translation along each of a plurality of planar regions; wherein during translation along each planar region: the camera pose is oriented at a fixed respective angle relative to the planar region, and a plurality of the enrollment images is obtained, each at different translations.

According to some embodiments of the present disclosure, for each of the planar regions, the obtained plurality of the enrollment images include images obtained from camera poses located on either side of an intersection with another of the planar regions.

According to an aspect of some embodiments of the present disclosure, there is provided a method of constructing a 3-D representation of an object using a plurality of 2-D images of the is object obtained from different camera poses, the method including: accessing the 2-D images; classifying regions of the plurality of 2-D images according to type; selecting sub-type detectors for the classified regions, based on type; sub-classifying the classified regions using the sub-type detectors; and constructing the 3-D representation, using the types and sub-types of the classified and sub-classified regions as a basis for identifying regions in different images which correspond to the same portion of the 3-D representation.

According to some embodiments of the present disclosure, the method includes associating geometrical constraints to the classified and/or sub-classified regions, based on their respective type and sub-type.

According to some embodiments of the present disclosure, the constructing the 3-D representation includes using the associated geometrical constraints to identify regions in different images which correspond to the same portion of the 3-D representation.

According to some embodiments of the present disclosure, the constructing the 3-D representation includes using the associated geometrical constraints to register regions in different images within the 3-D representation.

According to some embodiments of the present disclosure, the sub-classifying includes identifying sub-regions within the regions.

According to some embodiments of the present disclosure, the method includes associating sub-region geometrical constraints to the sub-regions, based on their respective sub-type.

According to some embodiments of the present disclosure, the constructing the 3-D representation includes using the associated sub-region geometrical constraints to identify regions in different images which correspond to the same portion of the 3-D representation.

According to some embodiments of the present disclosure, the constructing the 3-D representation includes using the associated sub-region geometrical constraints to register regions in different images within the 3-D representation.

According to some embodiments of the present disclosure, the sub-classifying includes assigning a sub-type to a whole region.

Unless otherwise defined, all technical and/or scientific terms used herein have the same meaning as commonly understood by one of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, will control. In addition, the materials, methods, and examples are illustrative only and are not intended to be necessarily limiting.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system” (e.g., a method may be implemented using “computer circuitry”). Furthermore, some embodiments of the present disclosure may take the form of a computer program product embodied in one or more computer readable medium(s) having computer readable program code embodied thereon. Implementation of the method and/or system of some embodiments of the present disclosure can involve performing and/or completing selected tasks manually, automatically, or a combination thereof. Moreover, according to actual instrumentation and equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computer using any suitable operating system. In some embodiments of the present disclosure, one or more tasks performed in method and/or by system are performed by a data processor (also referred to herein as a “digital processor”, in reference to data processors which operate using groups of digital bits), such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well. Any of these implementations are referred to herein more generally as instances of computer circuitry.

Any combination of one or more computer readable medium(s) may be utilized for some embodiments of the present disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable storage medium may also contain or store information for use by such a program, for example, data structured in the way it is recorded by the computer readable storage medium so that a computer program can access it as, for example, one or more tables, lists, arrays, data trees, and/or another data structure. Herein a computer readable storage medium which records data in a form retrievable as groups of digital bits is also referred to as a digital memory. It should be understood that a computer readable storage medium, in some embodiments, is optionally also used as a computer writable storage medium, in the case of a computer readable storage medium which is not read-only in nature, and/or in a read-only state.

Herein, a data processor is said to be “configured” to perform data processing actions insofar as it is coupled to a computer readable memory to receive instructions and/or data therefrom, process them, and/or store processing results in the same or another computer readable storage memory. The processing performed (optionally on the data) is specified by the instructions. The act of processing may be referred to additionally or alternatively by one or more other terms; for example: comparing, estimating, determining, calculating, identifying, associating, storing, analyzing, selecting, and/or transforming. For example, in some embodiments, a digital processor receives instructions and data from a digital memory, processes the data according to the instructions, and/or stores processing results in the digital memory. In some embodiments, “providing” processing results comprises one or more of transmitting, storing and/or presenting processing results. Presenting optionally comprises showing on a display, indicating by sound, printing on a printout, or otherwise giving results in a form accessible to human sensory capabilities.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a is computer implemented process such that the instructions which execute on the computer or other programmable apparatus provide processes for implementing the functions/acts specified in the flowchart and/or block diagram block or blocks.

### BRIEF DESCRIPTION OF THE SEVERAL VIEWS OF THE DRAWINGS

Some embodiments of the present disclosure are herein described, by way of example only, with reference to the accompanying drawings. With specific reference now to the drawings in detail, it is stressed that the particulars shown are by way of example, and for purposes of illustrative discussion of embodiments of the present disclosure. In this regard, the description taken with the drawings makes apparent to those skilled in the art how embodiments of the present disclosure may be practiced.

In the drawings:

FIGS. 1A-1B are a schematic flowcharts of methods of specifying visual inspection parameters for an item of manufacture, according to some embodiments of the present disclosure;

FIGS. 2A-2D schematically represent devices for camera pose setting and camera pose patterns used with enrollment imaging, according to some embodiments of the present disclosure;

FIG. 3 schematically illustrates effects of imaging a same region at different angles, according to some embodiments of the present disclosure;

FIGS. 4A-4D schematically illustrate effects of imaging a same region at different angles, according to some embodiments of the present disclosure;

FIG. 5 schematically illustrates effects of imaging a same surface at a constant relative angle, but different translational offsets, according to some embodiments of the present disclosure;

FIGS. 6A-6D schematically illustrate effects of imaging a same surface at a constant relative angle, but different translational offsets, according to some embodiments of the present disclosure;

FIG. 7 is a schematic flowchart illustrating a method of selecting camera poses appropriate to visual inspection of identified inspection targets, according to some embodiments of the present disclosure;

FIG. 8 is a schematic flowchart illustrating a method constructing a-D representation of an object using a plurality of-D images of the object obtained from different camera poses, according to some embodiments of the present disclosure; and

FIG. 9 is a schematic drawing of a system for specifying visual inspection parameters for an item of manufacture, according to some embodiments of the present disclosure.

### DESCRIPTION OF SPECIFIC EMBODIMENTS OF THE INVENTION

The present invention, in some embodiments thereof, relates to the field of quality inspection and more particularly, but not exclusively, to automated visual quality inspection.

### Overview

An aspect of some embodiments of the present disclosure relates to automatic identification of targets for visual inspection which are components of an item of manufacture, including identification of camera poses from which the identified inspection targets may be imaged in order to perform automatic inspection of instances of the item of manufacture. In some embodiments, camera poses are identified relative to the modeled positions of inspection targets identified upon the item of manufacture, as reconstructed from enrollment images taken of the item of manufacture from a plurality of different angles. Additionally or alternatively, in some embodiments, camera poses used for visual inspection are selected based on camera poses used for taking the enrollment images—either directly, or by modification.

Herein, the process of identifying of the inspection targets and camera poses is also referred to as “part enrollment” (the item of manufacture being referred as the “part” enrolled, whether or not it is a complete item in itself, or a component thereof). “Inspection targets” are those portions of an item of manufacture which are salient to visual quality inspection. They may include, for example, selected components, surfaces, connections and/or joints of the item of manufacture. In some embodiments, inspection targets are automatically identified from enrollment images, comprising a multiplicity of images of an example of the item of manufacture from a corresponding multiplicity of camera poses.

In some embodiments, more particularly, part enrollment comprises generation of a multi-dimensional model (MDM) of the item of manufacture, optionally comprising a 3-D model of the geometry of the item of manufacture, along with annotations associated to different inspection targets of the item of manufacture such as their type classification(s). Generation of the MDM is based largely on images of a representative example of the item of manufacture obtained from a variety of camera poses. In some embodiments, a plurality of these camera poses are also preserved for use as a basis for choosing camera poses used in the quality inspection plan itself. In some embodiments, the camera poses are also associated to related portions of the MDM, in particular to inspection targets identified in the MDM. The camera poses may be used and/or associated as-is, and/or modified as suitable for inspection.

An aspect of some embodiments of the present disclosure relates to part enrollment building the MDM in view of the requirements of its end use for planning quality inspection. This potentially makes the enrollment task more tractable; allowing omitting MDM features which are unnecessary to the end use, and/or reducing requirements for precision in certain aspects of the MDM representation of the item of manufacture.

Two particular things which, in some embodiments, a quality inspection plan determines are:
How to pose the camera in order to obtain useful images of inspection targets.
Where, within those useful images, inspection targets are positioned.

For accurate automatic visual inspection results, each of these is preferably provided with high precision. Surprisingly, the inventors have found that what is not necessarily required with similarly high precision—or even complete self-consistency—is analytical knowledge of the three-dimensional coordinates of inspection targets themselves. Practically, the MDM should be suitable for use in accurately framing projections of the inspected item's surfaces in images produced by an inspection camera. However, MDM omissions and/or errors in spatial position representation that don't interfere with framing of inspection targets are potentially tolerable.

In some embodiments of the present disclosure, some of the camera poses used to obtain images which are used for part enrollment are also found to be suitable (optionally with minor and/or analytically generated modifications) for eventual part inspection. Accordingly, the MDM is constructed, in some embodiments, so that it identifies for use in inspection planning a portion of the camera poses used to obtain part enrollment images used in its construction. That portion, in some embodiments, comprises a set of camera poses suitable for later inspecting the set of known inspection targets. Using camera pose data directly has the potential advantage of providing local calibration of inspection target positions with the frame of reference of a camera positioning system. For example, whatever camera pose was commanded to obtain a certain enrollment image can be repeated if it is determined that the enrollment image is also a useful image to use for some visual inspection test.

In some embodiments, selected camera poses may be subject to further modification; for example, modification by small offsets from particular camera poses, and/or interpolation between camera poses. Particularly when inspection results from enrollment images are used for camera pose validation, the modifications are optionally kept small enough to have predictably minimal effects on that validation; and/or the modifications are themselves verified using a new enrollment image taken from the modified camera pose.

Additionally or alternatively, enrollment image camera pose data can be useful more indirectly, as a way to calibrate the frame of reference used for camera positioning with the relative position of selected landmarks, for example, inspection targets. For inspection targets which are enough separated from each other (e.g., around a corner) that relative position error becomes likely, different calibrating camera poses and landmarks may be used, so that modeling error does not propagate into errors in camera positioning during actual inspections.

Additionally or alternatively, camera poses selected for use in actual inspections are determined relative to inspection target positions defined by the geometry of the MDM itself (and not necessarily with reference to camera poses used to take enrollment images). Even in this case, certain types of errors which can occur in reconstruction of the MDM geometry from enrollment images are potentially negligible; for example because the reconstruction is consistent except at the boundaries of differently-oriented surfaces, and/or because errors lie outside of regions which are targets for visual inspection. In some embodiments, reconstruction error lies within imaging and/or lighting tolerances; e.g., distance errors do not exceed the useful depth of field of a camera's optical system, and/or errors in lighting angle do not significantly impact on visual inspection results. It is noted that consistency of the same visual inspection procedure repeated over time is potentially more important than accuracy in the measurement of parameter values used in the initial design of the visual inspection procedure.

In some embodiments, planned inspection camera poses looking onto different surfaces in the MDM (e.g., surfaces at different angles, or other potentially disjoint portions of the MDM) are optionally defined relative to different respective frames of reference. This potentially allows positioning specification to maintain precision in pointing at inspection targets, even though the model itself may be imprecise in some of its spatial relationships. For example, a 1 cm error in the MDM-represented relative positions of a first and second surface of the item of manufacture need not generate error during actual inspection camera positioning if the camera poses are defined relative to positions of the surface (or some landmark on it) that the camera is viewing (e.g., rather than in some absolute 3-D spatial frame of reference). At the actual time of inspection, the frame of reference of the camera positioning system can be calibrated to these different frames of reference, e.g., using fiducial marks on the inspection system to measure final offsets, and/or care in positioning (and optionally re-positioning as necessary) of the sample to be inspected so that it is located as the camera motion control system “expects”. Optionally, calibration comprises another method, such as a contact sensor, and/or distance measurement device on the camera mount.

Optionally, the MDM is adjusted using inputs from one of these or another system of is calibration to bring it to a level of closer self-consistency. Potentially, this allows simplifying and/or omitting re-calibrations for each different sample and/or sample portion.

Preferably, the set of camera poses which is eventually used for performing inspections of samples of the item of manufacture is compact; i.e., it avoids redundant collection of images of inspection targets. From among a plurality of potentially redundant camera poses which could usefully image an inspection target, selection/determination criteria optionally include, for example: full image representation of an inspection target, full image representation of more than one inspection target, camera position closest to a particular angle (e.g., orthogonal) to an estimated surface angle at or near the inspection target, focus quality of the inspection target, and/or angular size of the inspection target. In some embodiments, verification comprising obtaining a valid automatic visual inspection result for an inspection target using a particular enrollment image is among the criteria which govern selection camera pose selection/determination.

What remains includes identifying the inspection targets themselves. This may be defined as arriving at a preferably unique identification of each inspection target, each appearing at least once (more than once being a common case) in a set of 2-D part enrollment images taken of an item from different viewing angles.

In some embodiments of the present disclosure, inspection targets are identified according to their appearance in 2-D enrollment images. The identification, in some embodiments, is performed using the product of a machine learning algorithm, trained on examples of inspection targets such as ports, labels, fasteners, surfaces, and or joins. In some embodiments, a plurality of special purpose detectors are provided, each trained to a different class (type) of inspection target.

It is preferable to inspect an inspection target based on its unique identification, even though it may appear in a plurality of enrollment images. Three dimensional modeling of the item of manufacture is a useful way to satisfy the criterion of uniqueness. Upon registering regions of each 2-D enrollment image to the 3-D model, areas of overlap on the model image the same feature.

Reference to a 3-D model can also help to satisfy other general inspection requirements; for example, keeping the camera and any moving mounting parts reliably out of contact with an item being inspected.

It has been noted that certain errors in 3-D modeling are potentially acceptable for purposes of inspection planning. For example, non-inspected features can remain vaguely positioned or even un-represented; surfaces can be allowed to “float”, disconnected and/or erroneously placed relative to each other. Even inspection targets can optionally be ignored (e.g., unsuccessfully identified) in some of the images, for example, images which do not show them clearly. Potentially, a 3-D representation is unnecessary (even if useful for other reasons); e.g., in some embodiments, 2-D surfaces are individually reconstructed in the MDM, each surface with its own corresponding set of inspection targets and camera poses and/or frame of reference. Model-free part enrollment is another optional type of embodiment, e.g., with each inspection target being associated with a corresponding group of camera poses found to be useful for generating inspection images of the inspection target, even though there may not be a direct representation of the spatial position of inspection targets with respect to each other and/or in a common frame of reference.

An aspect of some embodiments of the present disclosure relates to the use of semantic information associated with the semantic identification of features in 2-D images, as part of building an MDM. In particular, semantic identification is used to associate geometrical constraints to a target. The geometrical constraints in turn help to define a unique representation of the target within the MDM.

In some embodiments, identification of inspection targets is “semantic”, in the sense that a particular type-label for some inspection target associates to it additional information (semantic information) which goes beyond the mere type-label itself. Image-based inspection target identification in particular is referred to as “semantic segmentation”, as further described hereinbelow.

As an example: a region in an enrollment image semantically identified (labeled) as a “screw” is also thereby associated, in some embodiments of the present disclosure, to application-defined semantic information appropriate to a screw. In the case of quality inspection applications, the semantic information may include, for example: that the screw can be present or absent, that it can be tight or loose, and/or that it can be damaged in certain ways (e.g., a stripped slot or socket). Furthermore, the semantic information may include that the target is further characterized by some sub-typed semantic identification: for example, the screw has a particular size, socket/slot shape, and/or head geometry. This optionally triggers operation of one or more sub-type detectors, which operate to identify, e.g., which particular size, socket shape, and/or head geometry the screw possesses. This result may itself comprise a further semantic identification that associates the target with more particular semantic information.

Another example of geometric constraint is the orientation (upon a surface approximately normal the direction of the camera) of elements with a defined top and bottom. Ports in a grouping (e.g., a region of contiguous and/or regularly arranged ports), for example, is are optionally constrained to share a same orientation. Similarly, text regions on a label may be constrained to share an orientation.

A typical stage in generation of a 3-D scene from a plurality of 2-D images is the identification of overlap—which portions in different images correspond to same portions of the scene. In some embodiments of the present disclosure, semantic information is used to assist overlap identification, as part of generating spatially-representing portions of the MDM. Semantic information may also be used to help characterize the boundaries of semantically identified targets, through the introduction of geometric constraints. As part of inspection planning, semantic identifications made within the enrolled item of manufacture can be used to choose which inspection tests are applicable to particular inspection targets, and/or how they are performed.

Within the domain of quality inspection, semantically identified inspection targets may include characteristic geometrical features. For example, physical labels (e.g., tags and/or stickers) and many connector ports tend to have straight edges. Moreover, the straight edges are typically oriented parallel and/or at right angles to each other and/or other edges of the item of manufacture. As another example: screws and bolts have characteristic head shapes (e.g., round, hexagonal). This type of geometrical information can be “imported” as additional semantic information, which is optionally used to guide the MDM representation of the representative example of the item of manufacture.

For example, an image region semantically identified as “screw” may be constrained by associated semantic information to comprise a circular shape when viewed from a direction perpendicular to a presumed surrounding surface. Optionally, the screw appearance is constrained to be within a range of other shapes (e.g., depending on screw head style) when viewed from other angles. Application of such constraints potentially helps define screw positions more precisely, since some parts of the image of the screw may be ambiguous due to factors such as partial shadowing, reflection, and/or blending with the background.

Furthermore, the semantic identification can be used to imply geometrical constraints on the angle of the surrounding surface relative to the camera position—e.g., when the screw head appears circular, the surrounding surface is constrained to extend substantially perpendicular to the direction of the camera from the screw.

Geometrical constraints can also help to identify overlap. For example, a physical label semantically identified as a “sticker” may be viewed from a perpendicular direction in one image and from an oblique direction in another. By assuming (based on semantic information is available for stickers) that the obliquely viewed sticker is “really” a right-angled patch of the surface, a transform may be selected, so that matching of the two views to a same target is potentially made computationally easier.

It is noted that semantic identification based on a machine learning product may implicitly make use of geometrical features which could in principle be interpreted as corresponding to the same “semantic information” of geometrical constraints just described. However, the nature of machine learning, at least in the current state of technical understanding, does not directly (if at all) expose the features which lead to a certain classification to inspection or use. Accordingly, for purposes of descriptions herein, geometrical features and constraints are considered to be semantic information separate from any particular semantic identification, whether or not they may have played some role in the identification in the first place.

In some embodiments, semantic identifications are optionally made hierarchically—first identifying a semantic type, and then identifying a semantic sub-type. The sub-type may be a more particular semantic identification of the overall area which was first identified by type, and/or a semantic identification of portion of that overall area. For example, a single port may be sub-typed as a particular type of port; a port cluster may be sub-typed into a plurality of sub-regions, each of which is typed as an individual port and/or port type. The latter example also shows that the hierarchy can be more than two levels deep, e.g., port cluster to individual port; individual port to port type.

Operations to identify the sub-type may be triggered by (conditional on) the initial type identification; for example, a target semantically labeled “screw” is subjected, on that basis, to one or more detectors for more specific screw types (e.g., pan head, flat head, round head; standard slot, Phillips slot). As semantic identifications become more specific, their usefulness in overlap detection potentially is enhanced (since there may be fewer matching candidates to compare with, and/or since there may be a recognized feature which is identifying, like a slot orientation).

With region/sub-region identifications, the flow of the hierarchy can go either way. For example, port detectors may be triggered to run on port blocks; but conversely a port block detector may be triggered to run on ports which have been separately detected in proximity to each other. Type identification of larger regions can provide information (e.g., “this is a keyboard”) which helps inform not only which detectors to use on sub-regions, but also how those sub-regions relate to each other (e.g., keys of a keyboard should be spaced evenly).

Specificity may also assist in identifying geometrical constraints on the MDM. Some is geometrical constraints comprise information propagated from prior knowledge about a type to its modeled representation. Some geometrical constraints comprise information propagated between imaged instances of a type, potentially improving the geometrical self-consistency and/or richness of their modeled representations.

For example, the surrounding surface's angle relative to the camera pose may be more tightly constrained if a screw head profile seen from the side can be identified as a pan head (elliptical from oblique angles) rather than a round head (more spherical, and thus potentially less elliptical from oblique angles). This is an example of prior knowledge (e.g., the 3-D shape of a pan head screw) propagating into the representation of the part based on its identification as being of the pan head type.

As examples of geometrical constraint information propagating between instances:
Text and/or images can be extracted from within a semantically identified “label”, and used to mutually constrain angle and/or identity determinations.
Sub-regions of a larger area can be geometrically constrained, e.g., to share a same orientation, or to avoid overlap.
Same-typed regions can also be constrained to share geometrical properties; for example, all ports of a certain type are constrained to the same overall dimensions (e.g., of the clearest imaged example of that type), a same average dimension, or an otherwise calculated geometrical constraint.

### Terminology

Herein, the term “camera pose” refers to the position and related configuration parameters of a camera relative to an imaged subject. For example, the camera pose may specify positioning in six degrees of freedom (three spatial coordinates, three angular coordinates), and optionally include further degrees of freedom specifying, e.g., focus, exposure, aperture, and/or field of view. Optionally, the camera pose comprises parameters governing lighting, e.g., intensity, direction, and/or light source positioning.

Herein, semantic identifications comprise “labels” that identify a subject by type (i.e., they are classifications). Semantic identification may be performed in several ways; for example, manual assignment of a label, automatic identification of a well-defined property, and/or classification by a machine learning product. Semantic information comprises additional data which are allowed to accrue to the subject, based on its semantic identification.

Herein, the phrase “machine learning product” refers to a classification algorithm which is itself the output of a machine learning algorithm. The classification algorithm typically takes the is form of mathematical weights applied to inputs to generate a classification as an output, e.g., as implemented by a connected neural net. Following terminology of the field, the classification algorithm is said to be “learned” by the machine learning algorithm, typically through the use of a training data set. Members of the training data are preferably selected such that they represent internally distinguishing features of the domain of the inputs which the classification algorithm is used to classify.

Before explaining at least one embodiment of the present disclosure in detail, it is to be understood that the present disclosure is not necessarily limited in its application to the details of construction and the arrangement of the components and/or methods set forth in the following description and/or illustrated in the drawings. Features described in the current disclosure, including features of the invention, are capable of other embodiments or of being practiced or carried out in various ways.

### Specification of Visual Inspection Parameters

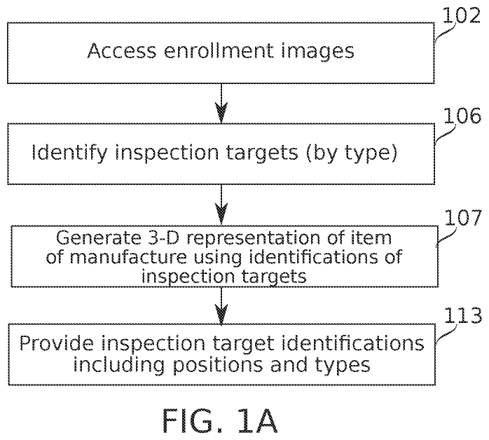

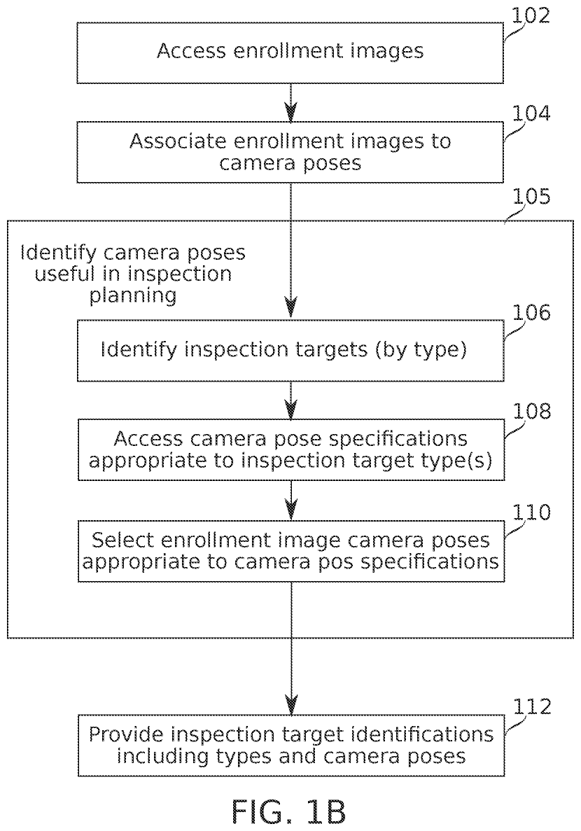

Reference is now made to FIGS. 1A-1B, which are schematic flowcharts of methods of specifying visual inspection parameters for an item of manufacture, according to some embodiments of the present disclosure. The method of FIG. 1A relates to a method that uses enrollment images to generate a 3-D model of an item of manufacture. This allows at least some camera poses used during later inspection to be determined with respect to the modeled 3-D positions of enrolled inspection targets. The method of FIG. 1B relates to a method that specifically tracks camera poses used during the obtaining of enrollment images as an input to inspection planning. The method of FIG. 1B optionally generates a model of the part being enrolled. The methods of FIGS. 1A and 1B are optionally performed as part of the same overall method, i.e.: a method that both generates and provides a 3-D representation of the item of manufacture (blocks 107 and 113, FIG. 1A), and tracks and selects camera poses from among those used in obtaining enrollment images (blocks 105 and 112, FIG. 1B) for use, e.g., in inspection planning. Since they share some features, and optionally overlap within a combined set of operations, the two methods are described in parallel.

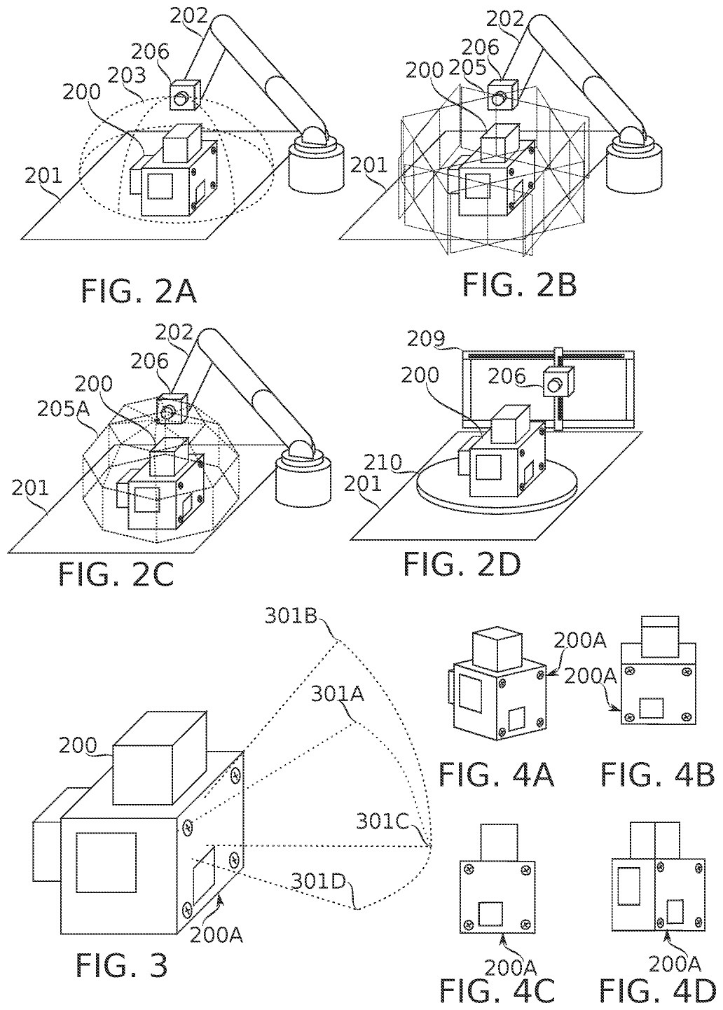

At block 102, in some embodiments (both of FIGS. 1A-1B), enrollment images of an item of manufacture are accessed. Patterns, procedures, and equipment optionally used for acquiring enrollment images are described in relation to FIGS. 2A-2D.

In general, the enrollment images comprise images taken from many different camera poses, comprising spatial positions around and/or within an example of the item of manufacture. Parameters of a camera pose may include, for example, positioning degrees of freedom is (translation and/or rotation in space), imaging angle, imaging aperture, exposure time, and/or camera focus. The example of the item of manufacture may be, e.g., fully assembled, partially assembled, and/or a pre-assembly component. In a simple example, the enrolled example is a “golden” part—that is, an example of the item of manufacture which exemplifies a target level of manufacturing quality. In some embodiments, enrollment imaging is performed using one or more defective examples.

In some embodiments, the imaging system comprises a robotically manipulated camera which moves to different locations near the example of the item of manufacture while taking images of it. Additionally or alternatively, the example of the manufactured item itself may be moved and/or manipulated during enrollment imaging; e.g., carried on a conveyor belt, rotated on a turntable, flipped over, or otherwise manipulated, e.g., opened to expose internal surfaces.

In some embodiments, a plurality of cameras is operated from a corresponding plurality of camera poses relative to the example of the item of manufacture (and optionally, each of the cameras itself images from a plurality of locations relative to the example of the item of manufacture).

In some embodiments, the enrollment images are taken using a same imaging system as will be later used to image instances of the item of manufacture for purposes of visual inspection. This is not a limiting condition, however; for example, the enrollment imaging camera and the later-used inspection imaging camera may be related through any suitable transformation and/or calibration to allow camera pose parameters from one system to be converted into corresponding camera pose parameters for another system.

The camera poses used may comprise any combination of automatically and/or manually chosen camera poses defined relative to the example of the item of manufacture, and/or relative to a reference location (e.g., a point or volume) which the example is registered to.

Automatically chosen camera poses may comprise, for example, camera poses within a movement pattern of the camera generated by a robotic manipulator. For example, the movement pattern may comprise movement to camera positions corresponding to points on a virtual shell within which the example is situated. This type of pattern requires little or no prior information about the design (e.g., geometry) of the item of manufacture, although it may require taking a large number of images from a large number of camera poses in order to ensure adequate sampling for later operations of the method.

Optionally, the selection of camera poses for enrollment imaging is somewhat guided and/or modified by the design of the item of manufacture. For example, robotic movements of is a camera may stay outside of bounds (defined, e.g., as a virtual box or cylinder) within which the example is confined. Optionally, rough analysis of some enrollment images is used to identify general angles and/or positions of surfaces (e.g., outlines of surfaces against a contrasting background), and the camera poses for further enrollment images selected to cover these surfaces from distances appropriate to obtaining needed resolution and/or focus quality. Manually selected camera poses may, for example, supplement images deemed missing from a set of automatically chosen camera poses. Optionally, all enrollment image camera poses are manually selected.

In some embodiments, camera poses are moreover associated with particular lighting conditions. For example, a plurality of lighting elements may be mounted to move along with the camera, and selectively activated. More oblique lighting may be used, for example, to help emphasize depth information (e.g., highlight scratches), while more perpendicular lighting may be used to help minimize artefactual image value irregularities, potentially enhancing the detectability of irregularities inherent in an instance of the manufactured item itself. For purposes of simplifying descriptions herein, lighting conditions should be understood to be an optional part of the camera pose specification itself (e.g., a change in lighting is treated as modifying the camera pose, even if parameters of the camera as such remain unchanged). However, there is no particular requirement that lighting conditions be subsumed to camera poses this way; e.g., enrollment images may be alternatively described as associated jointly with separate camera pose and lighting condition specifications.

Particularly in the case of the method of FIG. 1B, there is a potential advantage to imaging patterns which cover each surface portion of the sample item of manufacture being enrolled from multiple angles and/or distances, since each camera pose is not only a potential source of information about the inspection targets presented by the item of manufacture, but also how well those inspection targets are represented by images obtained from a certain camera pose. In the method of FIG. 1A, sparser coverage of the range of possible camera poses is potentially preferable, e.g., in cases where camera poses are to be determined primarily based on a 3-D model of the item of manufacture, rather than on camera poses which can be validated based on enrollment image results. Imaging patterns are discussed further, e.g., in relation to FIGS. 4A-6D.

At block 104, in some embodiments, (FIG. 1B) the enrollment images are associated with corresponding specifications of camera poses from which images were obtained.

In some embodiments, the configuration of the imaging system used to image the enrollment images is provided with each image, straightforwardly specifying the camera pose is associated with each image. Camera poses may be specified relative to the position of the example of the item of manufacture, and/or registered to it, e.g., via an intermediate fiducial mark, such as a mark on a mounting table.

For embodiments using robotically controlled camera poses, it is potentially convenient to record camera poses as their corresponding images are acquired. Camera poses may be e.g., recorded from position encoders of a robotic arm or other manipulator, and/or determined on the basis of commands issued to such a manipulator. When the enrollment and inspection systems are the same (or the same in type and configuration), there is similarly a potential benefit; e.g., insofar as positioning parameters can be directly replayed, without requirement for transformation/translation of camera pose parameters between potentially disparate positioning systems.

The method of FIG. 1A optionally uses camera poses obtained by one or more of the methods just described as part of the process of generating a 3-D representation of the item of manufacture, as described in relation to block 107 (FIG. 1B), hereinbelow.

Additionally or alternatively, camera poses may be extracted from the enrollment images themselves. In overview, the enrollment images are treated as each imaging, in their respective fields of view, different portions of a common set of surfaces belonging to the example of the item of manufacture.

Computational methods exist for estimating a 3-D configuration of surfaces consistent with an available set of available 2-D images of those surfaces, for example as further described in relation to block 107 of FIG. 1A. Estimation of the camera poses themselves arises as a consequence of many such computational methods—e.g., relative scales of the same region in two or more images are matched by adjusting estimated camera pose distances, and geometrical distortions are matched by adjusting estimated camera pose angles. A more particular method of estimating a 3-D model is discussed further hereinbelow in relation to embodiments which use the generation of such a 3-D model of the item of manufacture to assist in the unique identification of inspection targets.

While estimated camera poses are potentially more prone to error than directly tracked camera poses (e.g., camera poses recorded during imaging and/or used to control imaging), they have the potential advantage of not requiring the enrollment images to be obtained using hardware that can encode camera poses. For example, an enrollment workstation using a relatively inexpensive hand-adjustable camera mount and turntable may be used to obtain images which guide planning of inspection imaging by a robotic system. This may be useful, for example, to avoid taking a relatively more expensive robotic camera pose controller offline, and/or to allow enrollment imaging at a location remote from the production floor. Optionally, basic constraints of such a mounting system may be provided to a module which calculates camera poses from 2-D images; e.g., constraining sets of camera pose angles to a same value (or range of values), and/or constraining sets of camera poses to be consistent with translation of the camera along a same line, curve, or plane. Optionally, at least some free-hand photography is performed as part of enrollment image capture; however, camera pose extraction from such images is particularly liable to produce imprecise results due to factors such as variable photographer expertise, and/or reduced constraints on camera pose.

Within block 105 (FIG. 1B), in some embodiments, camera poses are identified for use as parameters guiding planning of automated visual inspection of the item of manufacture, based on the enrollment images and the corresponding camera poses.

More particularly, in some embodiments, the identification of camera poses comprises, in overview:
identifying inspection targets shown in the enrollment images (block 106),
accessing camera pose specifications appropriate to visual inspection of the inspection targets (block 108), and
selecting, from among the camera poses identified in block 105, camera poses which satisfy the camera pose specifications of block 108 (block 110).

In more detail:

At block 106 (FIG. 1B), in some embodiments, regions of the enrollment images are classified as including identified inspection targets.

Results of this operation preferably satisfy two goals: first, that physical elements of the item of manufacture which need specific visual inspection are classified based on their appearance in at least one of the enrollment images, and second, that the appearance of any one physical element in more than one of the enrollment images is unified as the appearances of that single physical element.

In some embodiments (e.g., as an optional part of the operations of block 106, or more particularly as an embodiment of block 107 of FIG. 1A) these goals are met in part by implementing a system that generates a 3-D model of the item of manufacture, by finding model and camera pose parameters that allow consistent mathematical back-projecting of enrollment images to surfaces of the item of manufacture. Views of the same element appearing in different images map to the same surface(s) of the 3-D model, and thereby are known to be views of that is same element.

A general approach to generating 3-D models from 2-D images is to identify candidate regions of correspondence in different images; and from this and geometrical constraints, find combinations of camera poses and 3-D configuration which jointly explain the correspondences by putting them in the same 3-D location (thus reaching the second goal). This allows the initial identification of correspondences to be optionally provisional (e.g., contain mistakes), although better initial identification of correspondences potentially eases the problem of 3-D modeling. The geometrical constraints may be strictly based on the images (e.g., that the features they show should be jointly and consistently mapped to some 3-D space), or optionally include additional information, such as known data about camera poses used to capture the enrollment images being assembled into a model.

There may be application-specific strengths and weaknesses of different methods used to identifying regions of correspondence. In some embodiments of the present disclosure, the eventual use of the enrollment of the item of manufacture is in inspecting identified inspection targets. Since the inspection targets are particularly salient, there is furthermore a potential advantage in using them preferentially as targets of correspondence finding. In view of embodiments of 3-D modeling wherein it may be particularly (and optionally only) inspection targets that are to receive unique identification, they are still further preferred as targets of correspondence finding. Advancing from this, in some embodiments corresponding to FIG. 1B, the correspondences that still more particularly matter are those between alternative views of inspection targets from camera poses that could be used in later visual inspection—since vague or indistinct views are irrelevant in any case. These considerations have been found by the inventors to present potential synergies within embodiments of present disclosure.

Accordingly, in some embodiments of the present invention, region correspondences among different enrollment images are defined using inspection targets themselves.

In some embodiments, a suite of feature detectors is defined for detecting well-imaged examples of a range of inspection target types, for example as described in International Patent Publication No. WO/2019/156783 A1, the contents of which are included herein by reference in their entirety. Examples of detectors include detectors for screws, for physical labels, for connectors (e.g., cable ports), or for surface finish properties. Detectors may by additionally provided for other types of components and/or features, for example, indicators, buttons, axles, wheels, closures, seams, welds, gaps, cracks, grills, holes, handles, pins, cabling and/or wiring.

Herein, such detectors are also referred to as “semantic detectors”, and the identifications they make are “semantic identifications”, as defined hereinabove. In some embodiments, is semantic detectors operate on a 2-D image to assign particular labels (semantic identifications) to defined regions of the 2-D image. Semantic detectors optionally comprise explicitly defined algorithms and/or machine learning products.

Further constraints applied to semantic identifications optionally vary by implementation. The identification itself (separate from its semantic character) may be useful; e.g., if camera pose information is separately available, it can be used to provide a strong constraint on which same-type classifications are identical. Spatial patterns of semantic identification regions may also be useful, although these may be broken across a plurality of images, making them less generally helpful.

In their character as “semantic”, semantic detectors have additional optional uses for correspondence finding. First, a semantic type may be associated with a particular shape as semantic information. Screws, for example typically have circular head profiles (at least as seen from perpendicular angles). Physical labels tend to have crisp and regular outlines—straight, or optionally circular, for example. There may be limitations on sizes, too—for example, screw heads may come in a range of sizes limited to certain steps.

Particular shapes or sets of available shape options, in some embodiments, are used as geometric constraints to identification of corresponding regions. Such geometric constraints potentially help to make geometric matches of corresponding regions more reliable. They can also assist in correctly identifying positions and/or surface angles of inspection targets.

Semantic type identifications, in some embodiments of the present disclosure, are implemented in stages. In some embodiments, the stages comprise a first discriminator stage to identify a region as comprising a broadly specified type of inspection target, and an optional second discriminator stage to identify the broad type as more specific type. In some embodiments, the stages comprise identifications of regions and sub-regions (in that or the reverse order).

The broad type “screw”, for example, can have numerous subtypes corresponding, e.g., to size, socket/slot shape, and head style. There may also be ancillary subtypes for related features such as washers and surrounding countersinking. In some embodiments, second stage discriminators identify particular subtypes, e.g., based on metric criteria (e.g., comparison to template shapes), and/or based on the use of machine learning products trained to distinguish instances of the different subtypes.

Subtype identifications may themselves be associated with further geometric constraints, and potentially more specific ones. For example, oblique imaging of a countersunk flat head screw gives a different expected shape than a round head screw. The difference may optionally be used as part of correspondence determination, and/or to help constrain estimations of angles of surfaces surrounding the screw. The orientation and/or off-perpendicular distortion of screw slot/socket shapes is another characteristic which may be used to constrain determinations of inspection target correspondence and/or 3-D reconstruction.

The screw slot/socket may also be considered as an example of a sub-region of the screw. Another type of sub-region identification is content regions comprising text, iconography, and/or other content of a physical label. At the first semantic stage, physical labels may be identified in outline, while at the second semantic stage, their content is segmented from within the label outlines. Further processing may be performed, e.g., parsing of text, or reading of bar-code information. Details of sub-regions are optionally used to identify correspondences among different images—e.g., screws with the same slot/socket orientation, or alignment of text in different images of the same label.

Other examples of sub-types include sub-types of surface finishes. For example, a surface region may be identified as having a “finish” type, of which examples of sub-types identifiable in some embodiments include one or more of: painted, crackle coated, brushed, polished, and/or level of reflectiveness (e.g., between matte and glossy).

Other examples of sub-types include sub-types of ports, port collections, and/or connectors. The outline of a collection of ports may be identified by a type, and sub-type detectors may be used to divide the port collection into individual ports. Ports (individually and/or collectively) may be identified according to sub-types including, for example, RJ-45, DIN-9, DIN-25, 3 mm audio, RCA, BNC, USB (according to any of the several types of USB port defined), HDMI, SFP (according to any of the several types of SFP port defined, including QSFP port types and/or OSFP port types), and/or another port type.

As noted hereinabove, it is not necessary, in some embodiments, to generate a full 3-D model, a fully consistent 3-D model (e.g., separate surfaces with shared edges exactly aligned), or even to generate any 3-D model at all. Similarly, 2-D representations of surfaces of the item of manufacture are not necessarily complete. In particular:
If a surface has no valid inspection targets, it need not be represented.
Insofar as distinct surfaces (e.g., different sides of a box-like manufactured item), do not share inspection targets, errors in determining their 3-D relationship may be negligible—so that it can be represented inaccurately or even not at all, without degrading planning of inspection imaging.
If an inspection target does happen to be identified more than once (e.g., as if it were is two different targets), this is not necessarily fatal to inspection planning, even if it does degrade inspection efficiency (by causing the same element to be inspected twice). Furthermore, there is no particular restriction on unifying separate identifications later in the process, e.g., as part of inspection planning itself.
Even surfaces with inspection targets need not be fully represented. If a particular image lacks any salient features (e.g., lacks any inspection targets), there is no particular requirement to use it; if a particular surface area is isolated from inspection targets so that it doesn't get “located”, it can be omitted from representation.

In some embodiments, instead of performing full 3-D reconstruction (model) of an item of manufacture, the item of manufacture is reconstructed per surface, with between-surface relationships left undefined and/or incomplete. For example, so-called RGB-D or “2.5-D” cameras are available which produce images encoding surface depth (distance from camera) as well as light returned from surfaces. In some embodiments, surfaces are segmented based on distance and/or orientation, and inspection targets identified based on their detection in image regions including a particular surface. Particularly if camera pose information is separately available, the surfaces can be treated independently of each other. Should a 3-D model be needed (e.g., for purposes of generating visualizations for an operator), there is no particular restriction on constructing it separately.

At block 108 (Figure JA), in some embodiments, specifications of appropriate camera poses appropriate to visual inspection of the identified inspection targets are accessed.

This is another instance where the semantic identification of the inspection targets is used to reference semantic information; in particular, what camera poses are appropriate to the particular type/sub-type of the inspection target.

The range of appropriate camera poses for an inspection target is optionally dependent on the inspection detector which will eventually be used. The camera pose specification may comprise, for example, parameters such as relative angle (e.g., camera positioned perpendicular to a surface of the inspection target, or at some oblique angle), distance, and/or required resolution. There may be more than one camera pose needed to inspect a certain inspection target. There may be a range of acceptable camera poses, of which some camera poses are more preferred than others.

In a special case, the appropriateness of a camera pose for visual inspection may be self-defined based on an actual attempt to use an enrollment image taken from that camera pose in an automated visual inspection test. If the test succeeds, the camera pose is at least provisionally appropriate. However, this may allow unstable edge cases to enter the camera pose specification. It is potentially more advantageous to use actual inspection test results as a double check on a range-based selection, for example as described in relation to block 110.

At block 110 (FIG. 1B), in some embodiments, camera poses are selected from among the camera poses identified in block 106, to satisfy the specifications of block 108. The parameters of one or more of the camera poses known from block 104 may be found to satisfy the specifications of block 108.

Potentially, none of the enrollment image camera poses satisfy the camera pose specifications. It should be noted that this is a possible situation, at least since (1) a detector may sometimes work correctly even outside its specified camera pose range, and (2) the detector used for enrollment is not necessarily the same (and/or operated the same) as the detector which is eventually used in actual inspections.

Optionally, in this case, further enrollment images are taken at new camera poses. Camera poses for these enrollment images are optionally guided by the camera poses which allowed the inspection target to be recognized in the first place. For example a focus setting may be selected which is between the settings for two camera poses which are off in different directions. This type of camera pose synthesis is potentially risky to results if not double-checked by actual imaging, however, minor adjustments to camera poses are optionally generated by extrapolation or interpolation where the validity of the result seems assured.

If more than one image satisfies the camera pose specifications, a selection is performed. The selection may be arbitrary when all candidate camera poses are equivalent in anticipated quality of result; or the camera pose specification itself may specify that some camera poses are more preferred than others.

There may also be higher level concerns to camera pose selection. For example, it may be preferable, in some embodiments, to reduce the number of inspection images needed to fully cover inspection of the item of manufacture. Thus, a camera pose which is no better than second-best for each of two different inspection targets may nevertheless be selected for use in preference to the best camera poses, which are nevertheless not useful for more than one of the inspection targets.

In some embodiments, camera poses are validated by testing the enrollment images as if performing the actual inspection task. Failure to get a result matching the known quality state of the example of the item of manufacture is an indication that the camera pose may not actually be appropriate to the inspection target.

Particularly in methods that produce a model of the spatial geometry of the item of manufacture (e.g, as in FIG. 1A), enriching the available enrollment images and corresponding camera poses is optionally omitted, at the potential increase of a risk that there will be skew between inspection results expected for a certain camera pose, and inspection results actually obtained.

At block 112 (FIG. 1B), in some embodiments, inspection target identifications, including the type and/or sub-type of the inspection target and its selected camera pose(s), are provided as parameters in a form suitable for use in planning visual inspection of the item of manufacture.

At block 113 (FIG. 1A), in some embodiments, inspection target identifications, including the type and/or sub-type of the inspection target and its modeled spatial position, are provided as parameters in a form suitable for use in planning visual inspection of the item of manufacture.

Optionally, features of blocks 112 and 113 are provided jointly.

In some embodiments, the type and/or sub-type of the inspection target is used by an inspection planner to select which inspection tests are to be performed. This is another example of a semantic identification being associated to semantic information—knowing the inspection target type, the planner understands what visual inspection tests are appropriate to inspect it.

As part of inspection planning, those visual inspection tests themselves are specified; and part of that specification is how their images are to be taken. The camera pose information provided with block 112 gives the inspection planner at least partially pre-validated information about how this may be done. Additionally or alternatively, inspection target positions of block 113 may be used to determine at what relative position a camera pose should be defined to allow test-specified imaging of the inspection target.

It should be understood that the provided camera pose (and its various sub-parameters) is not necessarily used as-is for the actual visual inspection test. It has already been mentioned that enrollment image camera poses are optionally adjusted to obtain more preferred camera poses, and this may optionally be performed at the inspection planning stage as well (though, again, with some risk unless the adjusted camera pose is validated).

Optionally, inspection planning accounts for the possibility that inspection targets will be presented for inspection at a partially indeterminate location. For example, visibility of a screw at the bottom of an access well may be dependent on positioning of the item of manufacture within tighter tolerances than are dependably achieved. In some embodiments, this is optionally compensated for by taking several images around a certain setting, effectively “fuzzing” the enrollment camera pose to help ensure that at least one image during actual inspection is useful.

The operations of FIGS. 1A-1B and other flowchart figures herein have been presented in a generally sequential (albeit interlaced) order for purposes of description. It should be understood that the operations of these figures are optionally performed with any suitable sequencing, iteration, degree of interlacing, and/or degree of simultaneity.

### Obtaining Enrollment Images

Reference is now made to FIGS. 2A-2D, which schematically represent devices for camera pose setting and camera pose patterns used with enrollment imaging, according to some embodiments of the present disclosure. Widget 200 represents a generic instance of an item of manufacture.

In some embodiments of the present disclosure, there is little prior information available describing an item of manufacture in a format which is available to the part enrollment system. Instead, the part enrollment system is bootstrapping itself into a sufficiently detailed representation of an item of manufacture to allow it to plan visual inspection.

FIG. 2A illustrates a hemispherical pattern 203 of movements, wherein a robotic arm 202 moves to keep camera 206 pointed toward a center of supporting surface 201 while moving around widget 200 at a constant distance from some central point of supporting surface 201. Images are optionally taken at selected nodes on the hemisphere, rather than continuously. Optionally, images from more than one hemispherical shell are obtained. While this pattern does a reasonable job of sampling each exposed surfaces (widget 200 can be turned or flipped to improve coverage) from some angle, it has the potential disadvantage that certain surfaces are only imaged obliquely—for example, parallel to the imaging plane of camera 206 but at the edge of the field of view of camera 206 and distorted; or centered but obliquely oriented to the imaging plane of the camera.

FIG. 2C illustrates a different mode of imaging, wherein camera pose movements are more “faceted”. A multiplicity of images are taken from camera positions along each facet of faceted pattern 205A, allowing a greater chance that surfaces will be imaged at a useful angle. Images taken from each facet use camera poses oriented to the same angle relative to the facet, but at different translations along the plane of the facet. In some embodiments, at least 3, 4, 9, 16, or another number of images are taken from camera poses translated to different positions along the plane of the facet.

FIG. 2B illustrates that the facets (only vertical facets are shown) can optionally extend into planar regions 205 beyond the facets of the polyhedral shell of faceted pattern 205A. Particularly when a narrow angular field of view and/or close camera working distance is used, is this potentially helps further increase the likelihood that a surface area will be photographed from a camera pose having an angle relative to the surface area which is useful for visual inspection. Again, images taken from each planar region use camera poses oriented to the same angle relative to the planar region, but at different translations along the plane of the planar region. In some embodiments, at least 3, 4, 9, 16, or another number of images are taken from camera poses translated to different positions along the plane of the planar region.

The patterns shown in FIGS. 2A-2C have the potential advantage of regularity, and simplicity of control of the camera poses. Optionally, the camera poses sampled are reactive to the particular shape of widget 200. For example, an RGB-D (2.5-D) camera can be posed so that the camera is at a certain estimated distance from the object at the image center, and angled so that the imaging plane is parallel to an estimated tangent plane of the object at the image center. This type of camera posing can be performed all over the object, optionally for a plurality of distances and/or for a plurality of imaging plane angles relative to the estimated tangent plane. Such a reactive scheme has a potential advantage for achieving a good balance of coverage and efficiency of imaging. Optionally, imaging plane angles are selected to match those which are generally present on the item of manufacture; e.g., a rectangular block-shaped item of manufacture may be imaged from a set of rectangularly arranged imaging planes aligned to the surfaces of the item of manufacture.

FIG. 2D illustrates a different imaging setup comprising a 2-axis frame camera mount 209, and a turntable 210. As long as widget 200 is stationary, movements of camera 206 up and down or back and forth in its 2-axis frame correspond to one of the extended-plane facets described in relation to FIG. 2B. Optionally, imaging angles at different elevations can be obtained by tilting turntable 210 to different angles, or by manipulating the angle of widget 200 itself on the turntable 210. Optionally, a third axis is added to frame camera mount 209, to allow manipulating camera-object distance. Alternatively, a translation axis is added to the mounting of turntable 210, allowing it to be moved, e.g., closer or further from camera 206 and its 2-D frame mount. It is noted that the system of FIG. 2D is potentially well suited to combined automatic and manual operation, since the degrees of freedom can be easily operated to move camera 206 in planar patterns, and appropriate planar regions can be easily selected by an operator who may rotate the turntable 210 to present different surfaces at an orientation parallel to the imaging plane of camera 206.

It should be noted that the imaging arrangements of FIGS. 2A-2D are well suited to the precise association of images with camera poses; by one or both of precise control of the camera according to a sequence of planned camera poses, and readout of camera pose from is position encoder data. In some embodiments, camera poses are calculated for images during a process of 3-D reconstruction of the item of manufacture using 2-D images of it. This may potentially allow the use of much simpler enrollment imaging setups, potentially even as simple as hand-held photography from several angles. However, this requires more operator expertise. Even if such enrollment images are taken with care, precision of inspection imaging camera poses may be still degraded (potentially unacceptably degraded), insofar as calculation-estimated camera poses may not replicate the results of actual camera poses when implemented in an inspection system.

It has been described hereinabove that lighting configurations may optionally be considered part of the camera pose. In some embodiments, lighting elements are furthermore fixed relative to the camera so that they move along with it. Optionally, lighting conditions are empirically worked out during the enrollment phase—different lightings being used for obtaining different particular images which may otherwise have the same associated camera pose parameters. The camera poses having the “best lighting” may be selected similarly to how other features of the camera pose are selected—according to predetermined criteria, and/or according to trial inspection results.

Additionally or alternatively, lighting conditions for inspection are set separately from other camera pose parameters, e.g., based on visual inspection test specifications appropriate to the type of the inspection target. For example, inspection tests for flaws in surface finishes may specify oblique lighting, even if the inspection target itself was not so-illuminated in the enrollment images that identified a finished surface in need of inspection. Even in such cases, verification by trial inspection during enrollment is still optionally made possible by accessing such test lighting specifications and integrating them into camera poses to obtain new enrollment images.

In general, any aspect of camera pose is optionally refined by an iterative process comprising: evaluating an initial enrollment image associated with an initial camera pose (e.g., according to the selection of block 110 of FIG. 1B); identifying a change in the initial camera pose which potentially will improve inspection results obtained using the changed camera pose (compared to the original camera pose); obtaining a new enrollment image using the change camera pose; and again evaluating the new enrollment image. The evaluating is performed with respect, e.g., to camera poses specified for a particular inspection target's type, and/or trial inspection of the example of the item of manufacture which is being imaged. In some embodiments, a plurality of examples of the item of manufacture are enrolled, e.g., a standard example without known flaws, and one or more examples with known flaws.

### Aspects of Camera Poses Relating to Visual Inspection Tests

Reference is now made to FIGS. 3-4D, which schematically illustrate effects of imaging a same region at different angles. FIG. 3 illustrates camera pose center rays 301A-301D, each impinging onto surface 200A of widget 200 from a different camera pose (and indicating the center of an image take from that camera pose). FIGS. 4A-4D (corresponding to images taken from angles 301A-301D, respectively) illustrate how surface 200A is differently foreshortened and/or angularly distorted in 2-D images, depending on image angle. For many inspection target types, the most perpendicular angle (in this case, angle 301C, corresponding to the view of FIG. 4C) is preferred and/or primary. Additionally or alternatively, a target inspection may make use of an oblique imaging angle, e.g., to help detect depth-related issues like a curling sticker, or an incompletely tightened screw.

However, angles somewhat diverging from the ideal may still be acceptable, e.g., within ±5°, ±10°, or another range of angles. In any case, at least some obliquity occurs even within an image wherein the imaging plane is parallel to its centered target surface; particularly approaching the image edges, and particularly with wide angular fields of view. Narrower fields of view (e.g., as shown in FIGS. 6A-6D) tend to reduce this, at the cost of more images potentially being needed to cover a given surface area. Acceptance of a camera pose angle as appropriate to a given inspection target optionally takes eccentricity of the inspection target in an image into account.

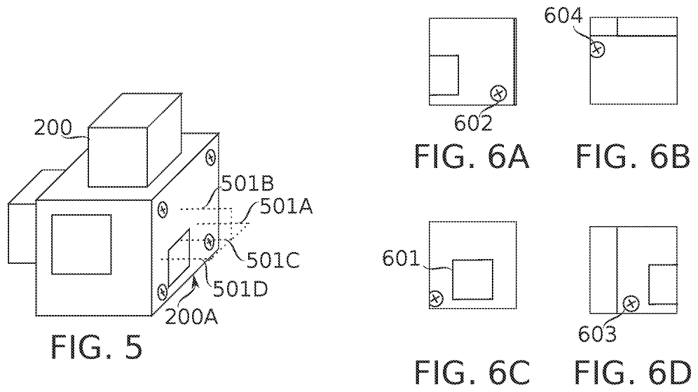

Reference is now made to FIGS. 5-6D, which schematically illustrate effects of imaging a same surface at a constant relative angle, but different translational offsets.

Again, surface 200A of widget 200 is the target. Camera pose center rays 501A-501D are each perpendicular to surface 200A, and corresponding images are shown in FIGS. 6A-6D, respectively, shown as for a relatively narrow field of view (compared to FIGS. 4A-4D) which captures only a portion of surface 200A. This illustrates the potential value of moving an imaging camera along substantially planar “facets”, as described in relation to FIGS. 2B-2C.

For any given inspection target (e.g., sticker 601, screws 602, 603), it is preferable that it appear fully within the image in order to be reliably recognized by its respective detector, as well as appearing in an image taken with a suitably oriented camera pose. For actual inspection, this may be not just preferable, but critical to producing accurate results. In some embodiments, identifiable but partial inspection targets (e.g., screw 604) are optionally flagged, for example, based on their presence too near the edge of their best available image's field of view. The camera pose may be modified for use in later inspection imaging to bring the marginal is inspection target closer to image frame center. The offset can be calculated, for example, by extracting offsets of image features in images taken from different camera poses with a known difference between them.

Identification of inspection targets is potentially facilitated by having images available with a whole inspection target contained within it. It should be understood that once images have been mapped to a common 3-D or 2-D space, their various regions can be stitched together to provide a synthesized image which potentially provides such a whole inspection target. It should also be recognized that some partial inspection targets (e.g., sub-parts of labels) are potentially identified based on the presence of characteristic sub-part features (e.g., label text). Effectively, the “whole inspection target” is, in such cases, also a sub-portion of a larger inspection target (the complete label).

### Methods of Selecting Camera Poses

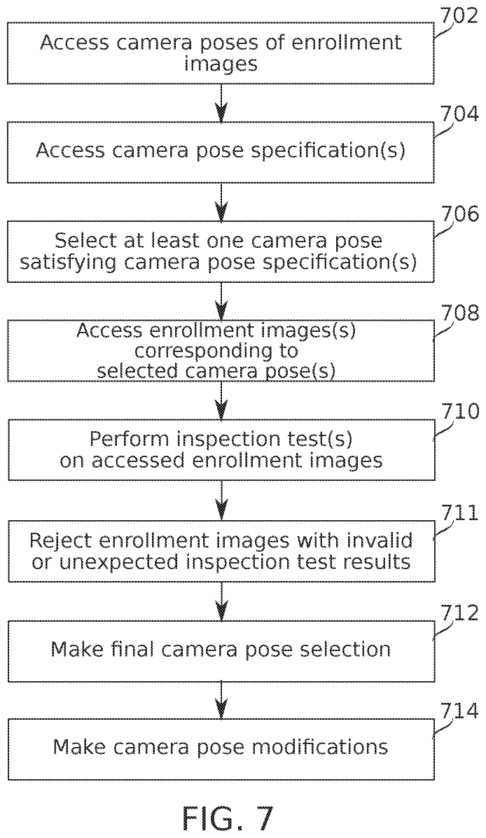

Reference is now made to FIG. 7, which is a schematic flowchart illustrating a method of selecting camera poses appropriate to visual inspection of identified inspection targets, according to some embodiments of the present disclosure. In some embodiments, the method of FIG. 7 corresponds to operations of block 110 of FIG. 1B. The method is specified for a single inspection target; it should be understood that operations of the method are typically performed for a plurality of inspection targets, in any appropriate sequential, simultaneous, or interlaced ordering.

At block 702, in some embodiments, camera poses are accessed, wherein the camera poses correspond to camera poses used to take enrollment images that include a view of the inspection target. As previously noted, there may be many more camera poses available than are appropriate for performing visual inspection tests. There may even be more appropriate camera poses available than are needed to carry out visual inspection.

At block 704, in some embodiments, camera pose specification(s) appropriate to the type(s) and/or subtype(s) of the inspection target (e.g., as identified in block 106 of FIG. 1B) are accessed (e.g., as described in relation to block 108 of FIG. 1B).

It should be understood that there may be more than one camera pose specification, e.g., since there may be more than one inspection test which is to be performed on inspection targets of the designated type and/or sub-type. There may also be more than one type identified (e.g., a keyboard may be both a “switch array” and an “indicator panel”), each associated with different tests; and there may similarly be more than one sub-type, and/or more than one sub-region associated with a sub-type. Sub-regions themselves may have their own associated camera pose is specification; e.g., different keys on a keyboard may each need to be inspected in images from camera poses at different absolute positions.

At block 706, in some embodiments, at least one camera pose is selected on the basis that it satisfies the specification(s) accessed at block 704. When more than one camera pose satisfies a same specification, selection include analysis of the available choices for a more-preferred option, e.g., one closer to the center of an available of camera poses range.

Alternatively, narrowing camera pose options down to a finally selected option is postponed until after additional checks are done, for example checks as explained in relation to blocks 708-710.

Blocks 708, 710, and 711 are optional. At block 708, in some embodiments, the enrollment image(s) which correspond to the camera pose(s) selected in block 706 are accessed, and provided as input to an automated visual inspection module, configured substantially as it would be for performing inspection tests in the course of later manufacturing activities.

At block 710, the inspection test is performed. If the example of the item of manufacture being enrolled is a “golden” (practically flawless) example, then the inspection result should be a pass. If the example has a known flaw with respect to the test, then that flaw should be indicated. At block 712, in some embodiments: if neither of the foregoing conditions is true, and/or if the inspection test fails for another reason (e.g., invalid input), then the camera pose selected at block 706 and now being checked is discarded as being not usable. This can happen, since whatever detector was used to discover the inspection target in the first place may have different input requirements and/or performance characteristics in its “detection” capacity than the inspection test module does in its “inspection” capacity.

Alternatively, in some embodiments, the criteria for even detecting the inspection target include detection of a flawless part (that is, the identification is optionally based in part on completely successful visual inspection, e.g., within block 106). In that case, re-testing of blocks 708-710 is omitted as redundant.

As mentioned, the confirmation testing of blocks 708-711 may be omitted, at the cost of accepting risk that a given camera pose is not actually useful for performing its designated inspection test, despite apparently fitting the criteria accessed at block 706. As an example of how this could happen, one may consider a physical label which is imaged slightly out of focus. The label detector could successfully identify the physical label, but the lack of good focus may nonetheless prevent identifying its textual content in an inspection test.

At block 712, in some embodiments: of the camera poses remaining (if any), final camera pose selection is made. This optionally takes into account additional criteria, such as a is preference for combined use by more than one inspection test and/or more than one inspection target of a single inspection image (and camera pose) when possible.

At block 714, in some embodiments, optional camera pose modification may occur. This may comprise, for example, imparting a parameter offset to a camera pose selected in block 712, e.g., to ensure that two camera poses are in a predefined relationship to one another, e.g., to allow stereoscopic processing for depth. Another modification may comprise “fuzzing” a selected camera pose (multiplying it to a plurality of associated, but slightly different camera poses). This may be used to account for possible positioning errors which may occur during later visual inspection. Alternatively, it may allow joint analysis (e.g., statistical analysis) of results from only slightly different imaging positions. The modifications of block 714, if needed, are alternatively postponed until the inspection test itself, and/or determined during inspection planning, rather than provided to inspection planning already pre-calculated.

### Methods of Constructing 3-D Representations

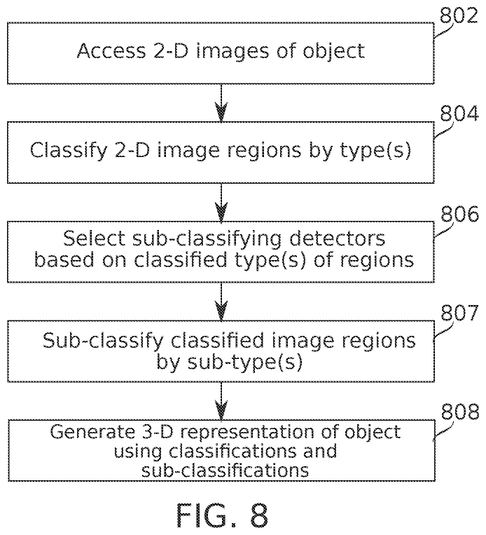

Reference is now made to FIG. 8, which is a schematic flowchart illustrating a method constructing a 3-D representation of an object using a plurality of 2-D images of the object obtained from different camera poses, according to some embodiments of the present disclosure.

At block 802, in some embodiments, 2-D images of the object (which may be, for example, an example of an item of manufacture) are accessed. The 2-D images are obtained from a plurality of respective camera poses; for example as described in relation to FIGS. 2A-2D.

At block 804, in some embodiments, regions of the 2-D images are classified according to type. The types, in some embodiments, are semantic identifications. In some embodiments, the types are more specifically semantic identifications associated with elements of items of manufacture, for example, ports (e.g., ports used for interfacing of electrical and/or electronic devices), physical labels (e.g., stickers, tags, and/or stencils), fasteners (screws, bolts, clips), surfaces (particularly finished surfaces), and or joins (e.g., welds, and/or seams between components which are fastened together using methods such as separate fasteners and/or integrally formed snaps). Type classification is optionally performed using a machine learning product trained to recognize elements of different types from their appearance in 2-D images.

At block 806, in some embodiments, one or more sub-type detectors for the classified regions of block 804 are selected. Section is per region, and based on the region type. For example, for a screw-typed region, sub-type detectors may include one or more detector is specialized for locating and classifying different slot/socket types. Other examples of sub-type classifications are described herein, for example, in the aspects of the overview, and/or block 106 of FIG. 1B. Examples of type/sub-type classification are also described in International Patent Publication No. WO/2019/156783 A1, the contents of which are included herein by reference in their entirety.

At block 807, in some embodiments, the selected sub-type detectors are applied to classified images regions, resulting in assigned sub-classifications.

At block 808, in some embodiments, a 3-D representation of the object imaged in the 2-D images is constructed, using the classifications and sub-classifications assigned in blocks 804 and block 806. In some embodiments, these assignments are used to identify candidates for overlap between 2-D images (which regions in different images show the same object surface). In some embodiments, classification assignments are used to associate geometric constraints to the regions, for example as described in the aspects of the overview. The geometrical constraints in turn are optionally used to help identify candidates for overlap, and/or to assist registration in 3-D of different 2-D images which share a same imaged region.

### System for Automatic Specification of Visual Inspection Parameters

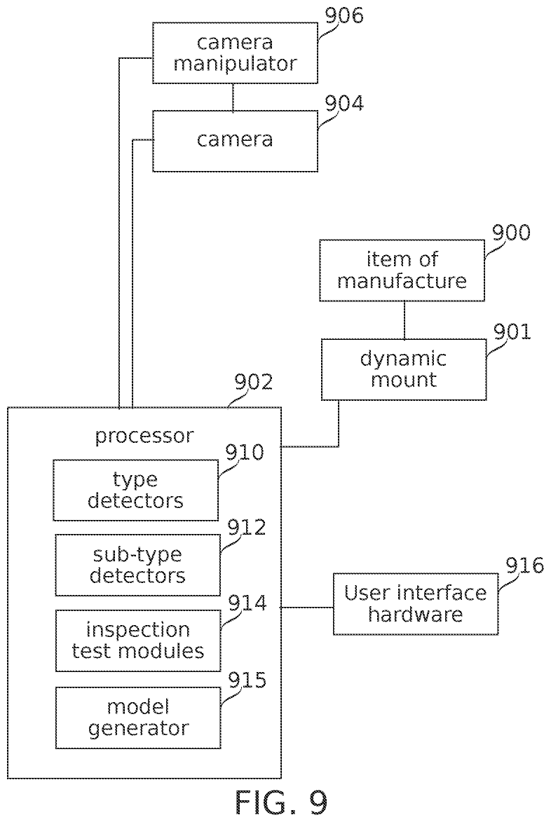

Reference is now made to FIG. 9, which is a schematic drawing of a system for specifying visual inspection parameters for an item of manufacture, according to some embodiments of the present disclosure. Elements of FIG. 8 are optionally present or omitted, depending on a particular configuration of an embodiment. It be understood from descriptions herein how configuration options may be combined in particular embodiments.

Item of manufacture 900 is the target of part enrollment (and not part of the system itself), for example as described in relation to FIGS. 1A-1B. Item of manufacture 900 may be statically mounted, or optionally mounted to an (optional) dynamic mount 901. Dynamic mount 901 may comprise a turn table, translation stage, or other mechanical device which is capable of applying controlled movements to item of manufacture 900 in one or more degrees of freedom.

Camera 904, in some embodiments, comprises a camera configured to obtain enrollment images. Camera manipulator 906, in some embodiments, comprises a robotic arm, frame mount, or other device configured to move the camera 904 to different (and preferably measured and/or accurately controlled) camera poses. As described herein, for example in relation to block 104, camera poses may alternatively be obtained by analysis of 2-D images taken using camera 904, e.g., as part of a process of 3-D reconstruction of the shape of item of manufacture 900.

Processor 902, in some embodiments, comprises a digital processor and memory storing programming instructions which the digital processor accesses to carry out computational aspects of methods described herein; for example, the methods of FIGS. 1A-1B, 7, and/or 8. More particularly, the memory of processor 902 may store programming instructions corresponding to one or more type detectors 910 (used to detect and classify inspection target types in 2-D images), one or more sub-type detectors 912 (used to sub-classify inspection targets of particular types, optionally including dividing them into sub-regions), and optionally one or more inspection test modules 914, which operate on image regions imaging inspection targets to determine if the inspection target is valid according to one or more inspection criteria. Optional model generator 915 is configured to generate a spatial model of the item of manufacture 900, using accessed images generated using camera 904, for example as described in relation to block 107 of FIG. 1A.

In some embodiments, processor 902 is functionally connected to control and/or receive data from one or more of camera 904, dynamic mount 901, and camera manipulator 906.

In some embodiments, processor 902 is functionally connected to user interface hardware 916, e.g., comprising input devices (keyboard, trackpad and/or mouse, for example) and/or display(s).

### General

As used herein with reference to quantity or value, the term “about” means “within ±10% of”.

The terms “comprises”, “comprising”, “includes”, “including”, “having” and their conjugates mean: “including but not limited to”.

The term “consisting of” means: “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

The words “example” and “exemplary” are used herein to mean “serving as an example, is instance or illustration”. Any embodiment described as an “example” or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the present disclosure may include a plurality of “optional” features except insofar as such features conflict.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

Throughout this application, embodiments may be presented with reference to a range format. It should be understood that the description in range format is merely for convenience and brevity and should not be construed as an inflexible limitation on the scope of descriptions of the present disclosure. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Although descriptions of the present disclosure are provided in conjunction with specific embodiments, it is evident that many alternatives, modifications and variations will be apparent is to those skilled in the art. Accordingly, it is intended to embrace all such alternatives, modifications and variations that fall within the spirit and broad scope of the appended claims.

It is appreciated that certain features which are, for clarity, described in the present disclosure in the context of separate embodiments, may also be provided in combination in a single embodiment. Conversely, various features, which are, for brevity, described in the context of a single embodiment, may also be provided separately or in any suitable subcombination or as suitable in any other described embodiment of the present disclosure. Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A method of specifying visual inspection parameters for an item of manufacture, the method comprising:
accessing a plurality of enrollment images of an example of the item of manufacture;
for each of a plurality of regions appearing in a respective image of the plurality of enrollment images, classifying the region as imaging an identified inspection target having an inspection target type;
generating, using the regions and their classifications, a spatial model of the item of manufacture which indicates the spatial positioning of inspection targets and their respective inspection target types; and
calculating camera poses for use in obtaining images appropriate to inspection of the inspection targets, based on their respective modeled spatial positions and inspection target types.

2. The method of claim 1, comprising identifying a change in an initial camera pose used to obtain at least one of the plurality of enrollment images, which said change potentially will provide an image with increased suitability for enrolling the identified inspection target, compared to the initial camera pose;
obtaining an auxiliary enrollment image using the changed camera pose; and
using the auxiliary enrollment image in the classifying.

3. The method of claim 1, wherein the calculated camera poses include camera poses not used in the enrollment images used to generate the spatial model of the item of manufacture, the calculated camera poses being relatively more suitable as inspection images of the inspection targets than the camera poses used in obtaining the enrollment images.

4. The method of claim 1, wherein the spatial model of the item of manufacture includes relative errors in the relative positioning of at least some surfaces of at least 1 cm.

5. The method of claim 1, wherein the generating the spatial model includes using the classifications to identify regions in different images which correspond to the same portion of the spatial model.

6. The method of claim 1, wherein the generating a spatial model comprises assigning geometric constraints to the identified inspection targets, based on the inspection target type classifications.

7. The method of claim 6, wherein the generating uses the assigned geometric constraints for estimating surface angles of the example of the item of manufacture.

8. The method of claim 6, wherein the generating uses the assigned geometric constraints for estimating orientations of the example of the item of manufacture.

9. The method of claim 6, wherein the generating the spatial model includes using the assigned geometrical constraints to identify regions in different images which correspond to the same portion of the spatial model.

10. The method of claim 1, wherein the enrollment images comprise 2-D images of the example of the item of manufacture.

11. The method of claim 1, wherein the classifying comprises using a machine learning product to identify the inspection target type.

12. The method of claim 1, comprising imaging to produce the enrollment images.

13. The method of claim 1, comprising synthesizing a combined image from a plurality of the enrollment images, and performing the classifying and generating also using a region within the combined image spanning more than one of said plurality of the enrollment images.

14. The method of claim 1, wherein the classifying comprises at least two stages of classifying for at least one of the inspection targets, and operations of the second stage of classifying are triggered by a result of the first stage of classifying.

15. The method of claim 14, wherein the second stage of classifying classifies a region including at least a portion of, but different in size than another region classified in the first stage of classifying.

16. The method of claim 14, wherein the second stage of classifying classifies a region to a more particular type belonging to a type identified in the first stage of classifying.

17. The method of claim 1, wherein the generating also uses camera pose data indicative of camera poses from which the plurality of enrollment images were imaged.

18.-42. (canceled)

43. A system for specifying visual inspection parameters for an item of manufacture, the system comprising a processor and a memory storing instructions which instruct the processor to:
access a plurality of enrollment images of an example of the item of manufacture;
for each of a plurality of regions appearing in a respective image of the plurality of enrollment images, classify the region as imaging an identified inspection target having an inspection target type;
generate, using the regions and their classifications, a spatial model of the item of manufacture which indicates the spatial positioning of inspection targets and their respective inspection target types; and
calculate camera poses for use in obtaining images appropriate to inspection of the inspection targets, based on their respective modeled spatial positions and inspection target types.

44. The system of claim 43, wherein the instructions instruct the processor to:
identify a change in an initial camera pose used to obtain at least one of the plurality of enrollment images, which said change potentially will provide an image with increased suitability for enrolling the identified inspection target, compared to the initial camera pose;
obtain an auxiliary enrollment image using the changed camera pose; and
use the auxiliary enrollment image in the classifying.

45. The system of claim 43, wherein the instructions instruct the processor to classify the region through at least two stages of classification for at least one of the inspection targets, and operations of the second stage of classification are triggered by a result of the first stage of classification.
